(19) United States
(12) Patent Application Publication
(10) Pub. No.: US 2023/0283938 A1
(43) Pub. Date: Sep. 7, 2023

(54) BONE CONDUCTION VIBRATOR AND BONE CONDUCTION BLUETOOTH EARPHONE

(71) Applicant: SHENZHEN YIYIN TECHNOLOGY CO., LTD, Guangdong (CN)

(72) Inventors: ZhongMing Song, Guangdong (CN); BinHua Cai, Guangdong (CN)

(73) Assignee: SHENZHEN YIYIN TECHNOLOGY CO., LTD, Guangdong (CN)

(21) Appl. No.: 17/846,016

(22) Filed: Jun. 22, 2022

(30) Foreign Application Priority Data
Mar. 4, 2022 (CN) 202220474482.4

(51) Int. Cl. H04R 1/10

(52) U.S. Cl. CPC H04R 1/10; H04R 2460/13; H04R 2420/07

(57) ABSTRACT

The present invention relates to a bone conduction vibrator and a bone conduction bluetooth earphone. The vibrator includes a circuit panel, a voice coil arranged under the circuit panel, a vibrating component including a bracket and a resilient plate, and a magnetic component generating a magnetic field connected with the resilient plate of the bracket. The circuit panel encloses the bracket on an end portion away from the resilient plate, with the voice coil under the circuit panel sticking or partially sticking into the magnetic component.

### CROSS-REFERENCE TO RELATED APPLICATION

This application claims the priority benefit of China application No. 202220474482.4, filed on Mar. 4, 2022. The entirety of the above-mentioned patent application is hereby incorporated by reference herein and made a part of this specification.

### BACKGROUND

### Technical Field

The present application relates to the field of electro-acoustic device, more particularly, to a bone conduction vibrator and a bone conduction bluetooth earphone.

### Description of Related Art

In a typical earphone market, speakers are designed to be an in-ear headset, or to be embraced in ear muffles on a bracket. It can impede hearing to wear conventional earphones for a long time. In addition, conventional earphones are not suitable in sports occasions, for being unable to release the ears.

As a bone conduction earphone is turned on, a bone conduction transducer drives a vibrating transmitting element to vibrate in a vibration frequency within an audio frequency range. Due to a tight fit between people's skin and a case of a conventional bone conduction earphone, vibration from the bone conduction earphone is transmitted through a human's skin, subcutaneous tissues and bones to the auditory nerve, thereby voice can be heard.

In a typical bone conduction earphone, a bone conduction speaker and an ear hook assembly are included. Within a limited space inside the speaker, a bone conduction transducer, button module and other relating components must be accommodated, which makes the bone conduction speaker bulky and unable to be made with compact and portable structure.

In addition, a magnet component in a conventional bone conduction earphone, includes a single U-shaped iron as a support, a magnet is provided inside the U-shaped iron to constitute the magnet component. However, with thinner and lighter development of the bone conduction speaker, the magnet component therein after size reduction has changed flux distribution, accompanied with losing electromagnetic susceptibility.

From the above, there are structural and electronic design problems in conventional bone conduction earphones.

### SUMMARY

In order to solve problems above, embodiments of the present disclosure provide a bone conduction vibrator and a bone conduction bluetooth earphone based on an integrated circuit panel, the circuit panel is used as a top cover of the vibrator and is also functioned as a circuit board of itself, with a voice coil under the circuit panel, simplifying inner electrical layout and structural design, facilitating functional extension, and achieving more lightweight, smaller volume, and better portability overall structure.

In an embodiment of the present application, it provides a bone conduction vibrator includes a circuit panel, a voice coil, a vibrating component and a magnetic component. The voice coil is arranged under the circuit panel. The vibrating component includes a bracket and a resilient plate placed inside the bracket. The magnetic component, generating a magnetic field, is connected with the resilient plate of the bracket. Wherein, the circuit panel encloses the bracket on an end portion away from the resilient plate, with the voice coil under the circuit panel sticking into or partially sticking into the magnetic component.

In another embodiment of the present application, it provides a bone conduction bluetooth earphone includes a bone conduction speaker and an ear hook assembly. The bone conduction speaker includes a speaker housing, a bone conduction vibrator and a functional circuit mounted inside the speaker housing. The bone conduction vibrator includes a circuit panel, a voice coil, a vibrating component and a magnetic component generating a magnetic field. The vibrating component includes a bracket and a resilient plate placed inside the bracket. The resilient plate is connected with the magnetic component. A main circuit board is mounted in the ear hook assembly. Wherein the circuit panel is electrically connected with the functional circuit and the main circuit board, the voice coil is arranged under the circuit panel, and the circuit panel encloses the bracket on an end portion away from the resilient plate, with the voice coil under the circuit panel sticking into or partially sticking into the magnetic component.

Beneficial effect of the embodiment in the present application includes as follows.

In the embodiments of the bone conduction vibrator and the bone conduction bluetooth earphone, overall dimensions of the vibrator are further reduced by improving electronic layout and structure design of the vibrator. In electronic layout aspect, top cover of the vibrator is fabricated with a circuit board, hereinafter referring to the circuit panel. The voice coil is directly attached to the circuit panel there under. A circuit board is adopted to serve as wiring circuit, and at the same time to serve as a top cover for the vibrator, so as to simplifying inner electrical and structural design of the vibrator.

In addition, in the embodiment of the bone conduction bluetooth earphone, an independent functional circuit is provided to connect a button circuit, a LED circuit or a microphone when necessary. Independent functional circuit facilitates realizing more function expansion, achieving more lightweight, smaller volume overall structure. And leaving out of a top panel element of the vibrator, weight of the earphone is reduced and portability thereof is improved.

Besides, the improved magnetic component in present embodiments includes multiple magnets and multiple magnetic conductive elements to provide sufficient magnetic flux distribution. Magnetic properties of the mini-structured magnetic component are enhanced, thereby improving sensitivity of the bone conduction bluetooth earphone, and improving power output of relating vibration and sound.

### BRIEF DESCRIPTION OF THE DRAWINGS

One or more embodiments will be described for exemplary purpose in accompany with corresponding drawings, which descriptions do not constitute limitation to embodiments of the present disclosure. Like reference numbers labeled in the drawings indicate similar components. Unless otherwise indicated, the drawings do not constitute limitation to the present disclosure.

FIG. 1 is an exploded structural view of a bone conduction bluetooth earphone provided in an embodiment of the present application;

FIG. 2 is an exploded structural view of a left bone conduction speaker and a left ear hook assembly in the embodiment of the present application;

FIG. 3 is an exploded structural view of a right bone conduction speaker and a right ear hook assembly;

FIG. 4 is an exploded structural view of a right ear hook assembly provided by the embodiment of the present application;

FIG. 5 is a section view of the bone conduction vibrator in the first embodiment of the present application;

FIG. 6 is a breakdown structural view of the bone conduction vibrator in the first embodiment;

FIG. 7 is a structural view of a bone conduction vibrator;

FIG. 8 is an inner section view of the bone conduction speaker of the present application;

FIG. 9 is a second inner section view of the bone conduction speaker of the present application;

FIG. 10 is a schematic diagram view of circuit connection of the bone conduction bluetooth earphone;

FIG. 11 is a structural view of a charger attachable with the bone conduction bluetooth earphone of the present application;

FIG. 12 is a section view of the bone conduction vibrator in the second embodiment of the present application.

### DESCRIPTION OF THE EMBODIMENTS

In order to illustrate the purpose, technical solutions and the advantages of the present application more clearly, the present application will be described below in further details with reference to the drawings and embodiments. It is to be understood that specific embodiments described herein are merely for explaining, instead of limiting the present application.

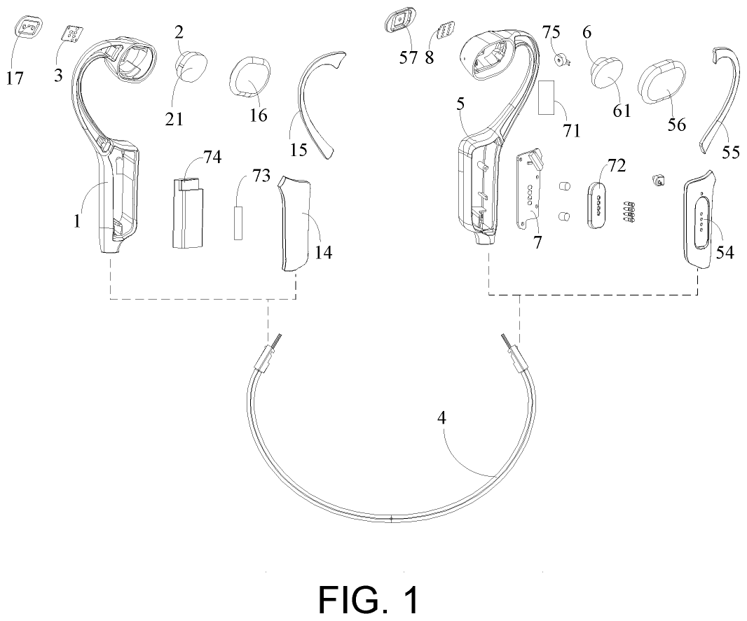

Referring to FIG. 1 to FIG. 4, showing inner structure of a bone conduction Bluetooth earphone. The bone conduction bluetooth earphone includes a left bone conduction speaker conducting sound by fitting into a user's head, a right bone conduction speaker, a left ear hook assembly, a right ear hook assembly and a wiring tube 4. The left bone conduction speaker is connected with the left ear hook assembly, and a rechargeable battery 74 is received in the left ear hook assembly. The right bone conduction speaker is connected with the right ear hook assembly. A main circuit board 7 and a magnetic charging assembly are provided in the right ear hook assembly. The left ear hook assembly and the right ear hook assembly are combined by the wiring tube 4. Circuit connecting wires in the left ear hook assembly and the right ear hook assembly are laid and routed along the wiring tube 4.

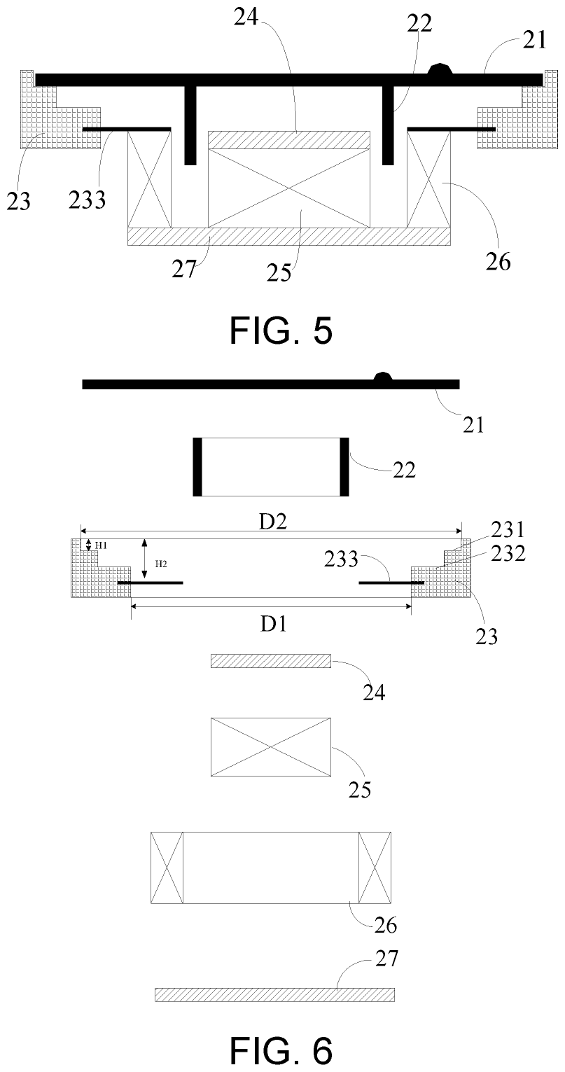

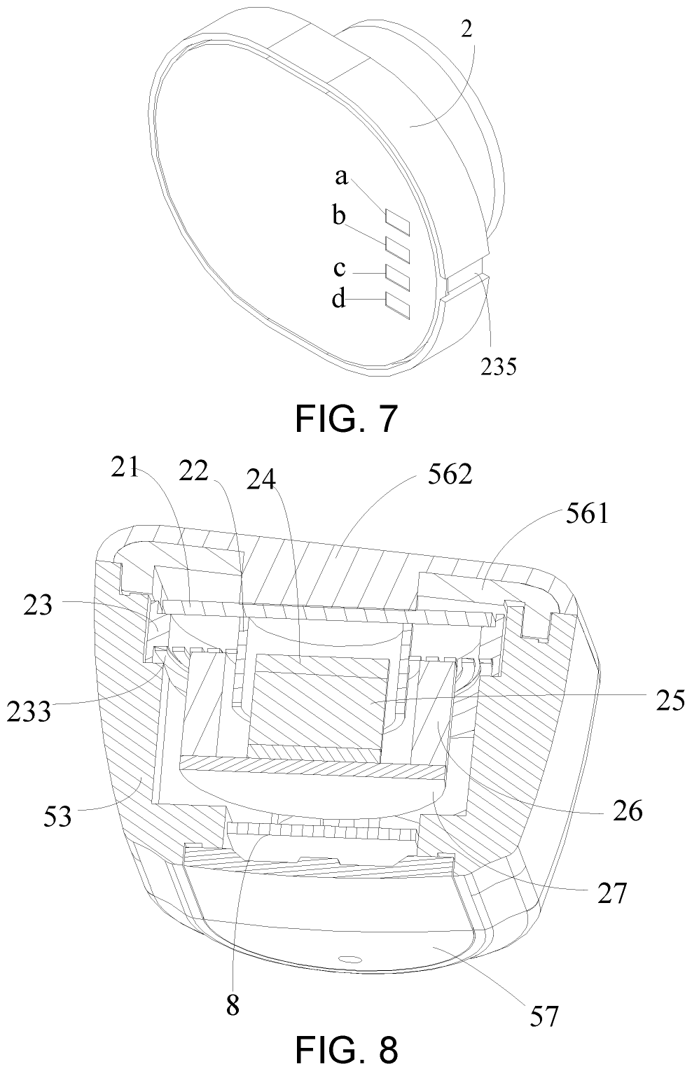

Referring to FIG. 5 to FIG. 7, together with FIG. 12, showing detailed structures of the bone conduction vibrator in different embodiments. The bone conduction vibrator in different embodiment is applicable to the left bone conduction speaker, and is also applicable to the right bone conduction speaker.

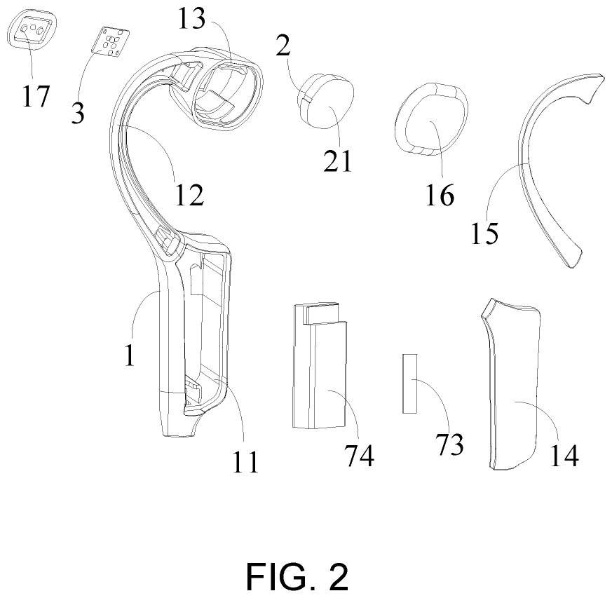

Please refer to FIG. 1 and FIG. 2, the left Bluetooth ear phone includes a left base 1 having a left main housing 11, a left connecting portion 12 and a left speaker housing 13. A battery chamber is defined by the left main housing 11 and a left main cover 14. A left speaker chamber is defined by the left speaker housing 13 and a left contact cover 16.

The rechargeable battery 74 is received in the battery chamber. A left button 17, a left functional circuit 3 and a left bone conduction vibrator 2 are accommodated inside the left speaker chamber. The rechargeable battery 74 is electrically connected with a main circuit board 7 in the right ear hook assembly by a flexible printed circuit 73 and connecting wires through the wiring tube 4. The left functional circuit 3 is electrically connected with a left circuit panel 21 of the left bone conduction vibrator 2. The left circuit panel 21 is electrically connected with the main circuit board 7 by connecting wires.

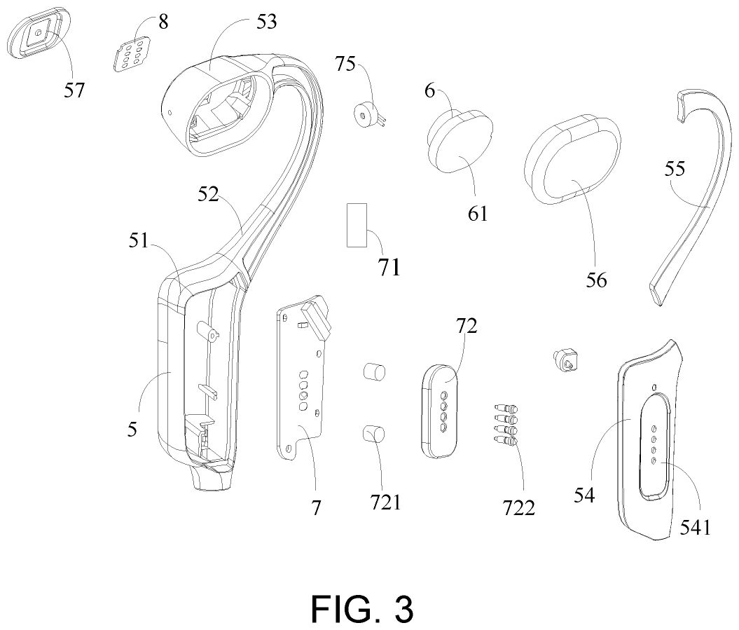

Please refer to FIG. 3, right Bluetooth earphone includes a right base 5, having a right main housing 51, a right connecting portion 52 and a right speaker housing 53. A receiving chamber is defined by the right main housing 51 and a right main cover 54. A right speaker chamber is defined by the right speaker housing 53 and a right contact cover 56 pressing the skin of a subscriber.

The main circuit board 7 and the magnetic charging assembly are mounted inside the receiving chamber. A memory card 71 can be inserted and connected with the main circuit board 7 and a Bluetooth module 77 is connected therewith. The Bluetooth module 77 can be wirelessly connected with terminals nearby to provide more online audio service. The magnetic charging assembly includes plurality of first charging pins 722 disposed on the main circuit board 7. Two inner magnetic buckles 721 are mounted besides the first charging pins 722. In present embodiment, the first charging pins 722 can be chosen from 4 pins or 2 pins according to different charging mode.

In right speaker chamber of the right Bluetooth earphone, a right button, a right functional circuit 8 and a right bone conduction vibrator 6 is accommodated. The right functional circuit 8 is electrically connected a right circuit panel 61 of the right bone conduction vibrator. The right circuit panel 61 is electrically connected with the main circuit board 7 by connecting wires along the right connecting portion 52.

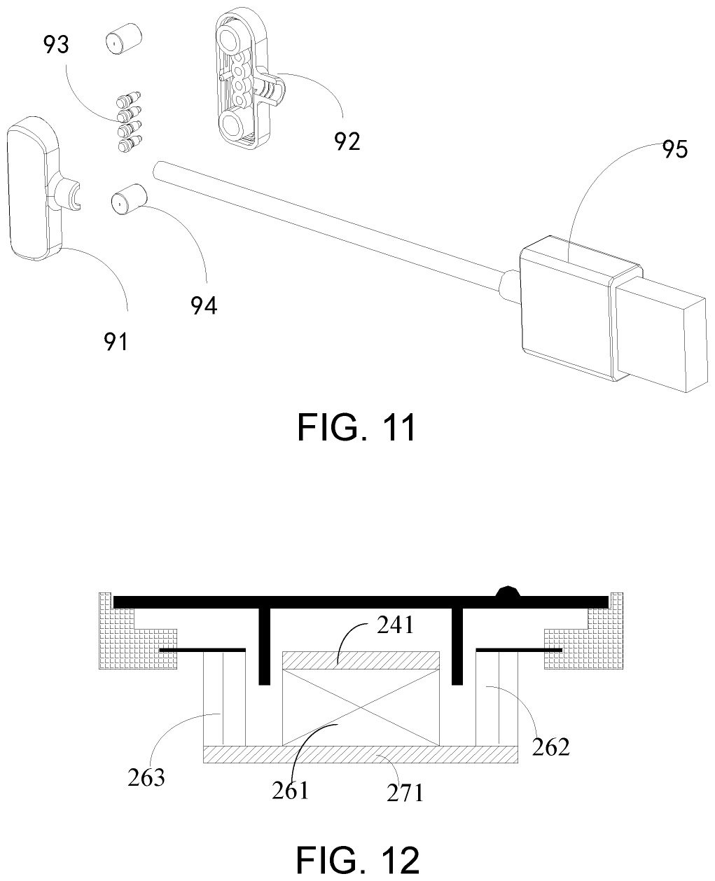

Referring to FIG. 11 together, corresponding to the magnetic charging assembly, the bone conduction bluetooth earphone further includes a magnetic charger capable of being connected with the first charging pins 722. The magnetic charger includes a first case 91 and a second case 92. A mounting chamber is defined by the first case 91 and the second case 92. Plurality of second charging pins 93 and outer magnetic buckles 94 are disposed in the mounting chamber. The plurality of second charging pins 93 is connected with a USB plug 95. In charging process, the inner magnetic buckles 721 attracts the outer magnetic buckles 94, aligning the first charging pins 722 and the second charging pins 93 and attached with each other to start charging the rechargeable battery 74.

As shown in FIG. 3, in order to facilitate the second charging pins 93 of the magnetic charger smoothly sliding into and docking the first charging pins 722, a recessed magnetic charging station 541 is formed on the right main cover 54 of the right earphone. Plurality of through holes are defined in the magnetic charging station 541 corresponding to the first charging pins 722 thereof.

Referring to FIG. 5 to FIG. 7, showing the detailed structure of the right bone conduction vibrator for example. It is understood that detailed structure of the left bone conduction vibrator is the same with the right one, therefore the left and right aforementioned description is ignored. The bone conduction vibrator includes a circuit panel 21, a voice coil 22, a vibrating component and a magnetic component generating a magnetic field.

The circuit panel 21 is electrically connected to corresponding functional circuit and the main circuit board 7 in the right ear hook assembly. The voice coil 22 is attached to the circuit panel 21 thereunder. The vibrating component includes a bracket 23 and a resilient plate 233 embedded inside the bracket 23. The resilient plate 233 of the bracket 23 is combined with the magnetic component. The circuit panel 21 encloses the bracket 23 on an end portion away from the resilient plate 233, with the voice coil 22 under the circuit panel 21 sticking into or partially sticking into the magnetic component.

Plurality of connecting ports are provided on top surface of the circuit panel 21. A wiring slot 235 is defined along a side wall of the bracket close to the connecting ports. In present embodiment, four connecting ports are formed on the circuit panel 21, including a port a, a port b, a port c and a port d. The port a, and the port b respectively referring to a positive electrode and a negative electrode are connected with the main circuit board 7. The port c, and the port d representing a positive electrode and a negative electrode are connected with corresponding functional circuit, such as the functional circuit 3 or the functional circuit 8.

Please refer to FIG. 2 and FIG. 3, in the embodiment, Plurality of connecting terminals are formed on the left functional circuit 3 or the right functional circuit 8. A button circuit, a microphone and/or at least one LED circuit are respectively connected with corresponding functional circuit by the connecting terminals.

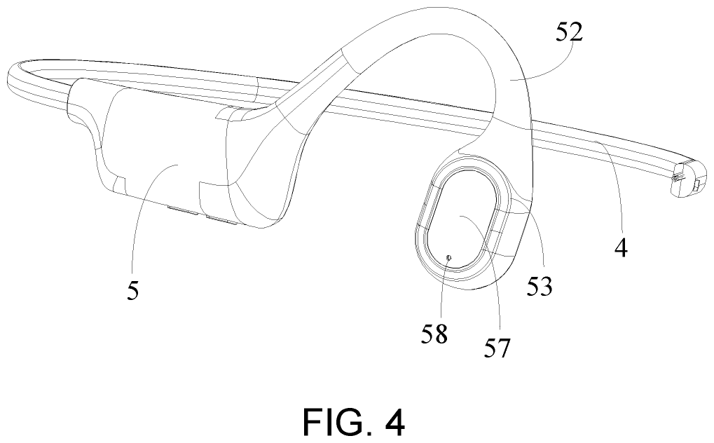

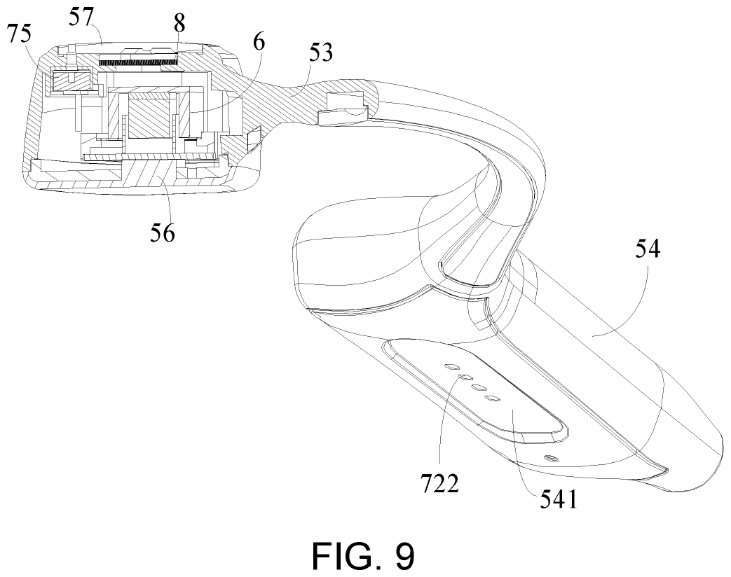

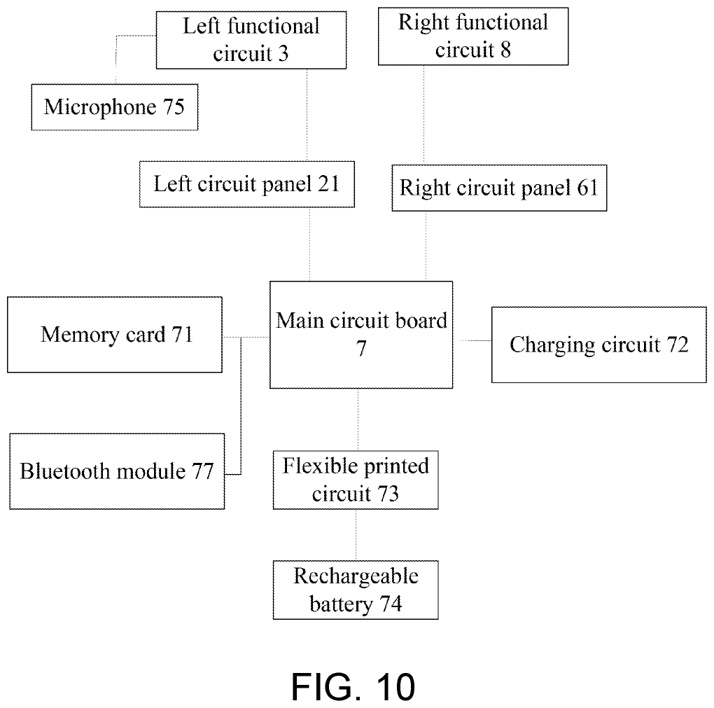

Referring to FIG. 8 and FIG. 9 together, in present embodiment, the functional circuit has a button circuit, and is connected to a microphone 75. As shown in FIG. 4, the microphone 75 is mounted in the speaker housing of the bone conduction speaker. Please refer to FIG. 3, a sound hole is defined through a side wall of the speaker housing. Or in other embodiment, referring to FIG. 4, a sound hole 58 is defined through the right button.

Please refer to FIG. 6, a first step 231 and a second step 232 are formed along inner circumferential wall inside the bracket 23. The first step 231 is designed to place the circuit panel 21, lined up with a top edge of the bracket 23. The resilient plate 233 is embedded in the second step 232.

A diameter of the circuit panel 21 is approximated or substantially approximated to a first internal diameter D1 of the bracket 23 at the first step 231. A first height H1 is defined between the first step 231 and the top edge of the bracket 23, and the first height H1 is equal to a thickness of the circuit panel 21.

A second height H2 is defined between the resilient plate 233 and a top edge of the bracket 23. The second height H2 is provided to show a position relation between the voice coil 22 and the magnetic component. For example, when value of the second height H2 is getting larger, interval between the circuit panel 21 and the magnetic component will get bigger, reducing intervening depth of the voice coil 22 into magnets of the magnetic components.

As shown in FIG. 6, in the first embodiment of the bone conduction vibrator, two magnets are used to form the magnetic flux field. The improved magnetic component in present embodiments includes multiple magnets and multiple magnetic conductive elements to provide sufficient magnetic flux distribution. Magnetic properties of the mini-structured magnetic component are enhanced, thereby improving sensitivity of the bone conduction bluetooth earphone, and improving power output of relating vibration and sound.

In the first embodiment of the vibrator, the magnetic component includes a first magnetic conductive element 27, a first magnet 25, a second magnet 26 and a second magnetic conductive element 24. The first magnet 25 is mounted on the first magnetic conductive element 27. The second magnet 26 is mounted on the first magnetic conductive element 27, encircling the first magnet 25. The second magnetic conductive element 24 is placed on top of the first magnet 25, and a top edge of the second magnet 26 is attached to the resilient plate 233.

Please refer to FIG. 12, in the second embodiment of the bone conduction vibrator. The second magnet is no longer used. The second magnet 26 together with the first magnetic conductive element 27 is replaced by a U-shaped iron or a magnetic conductive support formed by means of mounting a metal ring 262 onto the first magnetic conductive element 271, to assemble a first magnet 261. In present embodiment, the magnetic component includes the magnetic conductive support described above, the first magnet 261 and a third magnetic conductive element 241. The first magnet 261 is mounted on the magnetic conductive support, and the magnetic conductive support encircles the first magnet 261. The third magnetic conductive element 241 is placed on top of the first magnet 261. A top surface of the magnetic conductive support is attached to the resilient plate 233. A balancing weight ring 263 can be assembled with the magnetic conductive support. The balancing weight ring 263 is chosen from different weights according to different product series, to provide different wearing experiences of the bone conduction Bluetooth earphone.

Disclosures above only describe embodiments of the present application, and should not be deemed as limiting the protection scope of the present application. Equivalent structures or procedures made based on the specification and drawings, or applied to alternative associated technical areas directly or indirectly should also fall within the protection scope of the present application.

What is claimed is:

1. A bone conduction vibrator comprising
a circuit panel;
a voice coil, arranged under the circuit panel;
a vibrating component, comprising a bracket and a resilient plate placed inside the bracket; and
a magnetic component, generating a magnetic field, connected with the resilient plate of the bracket,
wherein, the circuit panel encloses the bracket on an end portion away from the resilient plate, with the voice coil under the circuit panel sticking into or partially sticking into the magnetic component.

2. The bone conduction vibrator of claim 1, wherein a first step and a second step are formed inside the bracket, the circuit panel is placed on the first step, lined up with a top edge of the bracket, and the resilient plate is embedded in the second step.

3. The bone conduction vibrator of claim 2, wherein a diameter of the circuit panel is approximated or substantially approximated to a first internal diameter of the bracket at the first step, a first height is defined between the first step and the top edge of the bracket, and the first height is equal to a thickness of the circuit panel.

4. The bone conduction vibrator of claim 1, wherein a second height is defined between the resilient plate and a top edge of the bracket, and the second height is provided to show a position relation between the voice coil and the magnetic component.

5. The bone conduction vibrator of claim 1, wherein the magnetic component comprises a first magnetic conductive element, a first magnet, a second magnet and a second magnetic conductive element, the first magnet is mounted on the first magnetic conductive element, the second magnet is mounted on the first magnetic conductive element encompassing the first magnet, the second magnetic conductive element is arranged on top of the first magnet, and a top surface of the second magnet is connected with the resilient plate.

6. The bone conduction vibrator of claim 1, wherein the magnetic component comprises a magnetic conductive support, a first magnet and a third magnetic conductive element, the first magnet is mounted inside the magnetic conductive support, the magnetic conductive support encircles the first magnet, the third magnetic conductive element is placed on top of the first magnet, a top edge of the magnetic conductive support is connected with the resilient plate, and a balancing weight ring is combined with the magnetic conductive support.

7. The bone conduction vibrator of claim 1, wherein plurality of connecting ports are provided on a top surface of the circuit panel, and a wiring slot is defined along a side wall of the bracket close to the connecting ports.

8. A bone conduction bluetooth earphone, comprising:
a bone conduction speaker, comprising a speaker housing, a bone conduction vibrator and a functional circuit mounted inside the speaker housing, the bone conduction vibrator comprising a circuit panel, a voice coil, a vibrating component and a magnetic component generating a magnetic field, and the vibrating component comprising a bracket and a resilient plate placed inside the bracket and connected with the magnetic component; and
an ear hook assembly, a main circuit board mounted in the ear hook assembly;
wherein the circuit panel is electrically connected with the functional circuit and the main circuit board, the voice coil is arranged under the circuit panel, and the circuit panel encloses the bracket on an end portion away from the resilient plate, with the voice coil under the circuit panel sticking into or partially sticking into the magnetic component.

9. The bone conduction bluetooth earphone of claim 8, wherein plurality of connecting terminals are provided on the functional circuit, a button circuit, a microphone and/or at least one LED circuit are respectively connected with the functional circuit by the connecting terminals, the microphone is mounted in the bone conduction speaker, and a sound hole is defined through a button or the speaker housing of the bone conduction speaker corresponding to the microphone.

10. The bone conduction bluetooth earphone of claim 8, wherein a first step and a second step are formed on an inner circumference inside the bracket, the circuit panel is placed on the first step, lined up with a top edge of the bracket, and the resilient plate is embedded in the second step.

11. The bone conduction bluetooth earphone of claim 10, wherein a diameter of the circuit panel is approximated or substantially approximated to a first internal diameter of the bracket at the first step, a first height is defined between the first step and the top edge of the bracket, and the first height is equal to a thickness of the circuit panel.

12. The bone conduction bluetooth earphone of claim 8, wherein the magnetic component comprises a first magnetic conductive element, a first magnet, a second magnet and a second magnetic conductive element, the first magnet is mounted on the first magnetic conductive element, the second magnet is mounted on the first magnetic conductive element encompassing the first magnet, the second magnetic conductive element is arranged on top of the first magnet, and a top surface of the second magnet is connected with the resilient plate.

13. The bone conduction bluetooth earphone of claim 8, wherein the magnetic component comprises a magnetic conductive support, a first magnet and a third magnetic conductive element, the first magnet is mounted inside the magnetic conductive support, the magnetic conductive support encircles the first magnet, the third magnetic conductive element is placed on top of the first magnet, a top edge of the magnetic conductive support is connected with the resilient plate, and a balancing weight ring is combined with the magnetic conductive support.

14. The bone conduction bluetooth earphone of claim 8, wherein the main circuit board is connected with a rechargeable battery, plurality of first charging pins are provided on the main circuit board, and inner magnetic buckles are arranged beside the first charging pins.

15. The bone conduction bluetooth earphone of claim 14, wherein further comprising a magnetic charger, the magnetic charger comprises plurality of second charging pins and outer magnetic buckles, in charging process, the inner magnetic buckles attracts the outer magnetic buckles each other, to make the first charging pins and the second charging pins aligned and tightly attached to start charging the rechargeable battery.
